(19) United States
(12) Patent Application Publication
(10) Pub. No.: US 2016/0034255 A1
(43) Pub. Date: Feb. 4, 2016

(54) Arithmetic Devices, Montgomery Parameter Calculation Method and Modular Multiplication Method Thereof

(71) Applicant: Samsung Electronics Co., Ltd., Suwon-si (KR)

(72) Inventors: Sun-Soo Shin, Seoul (KR); Jonghoon Shin, Hwaseong-si (KR); KyoungMoon Ahn, Seoul (KR); Yong Ki Lee, Suwon-si (KR)

(21) Appl. No.: 14/722,761

(22) Filed: May 27, 2015

(30) Foreign Application Priority Data
Aug. 4, 2014 (KR) 10-2014-0099941

(51) Int. Cl. G06F 7/523

(52) U.S. Cl. CPC G06F 7/523

(57) ABSTRACT

Disclosed are arithmetic devices, a method of a Montgomery parameter calculation thereof and a Montgomery multiplication method thereof. The method of the Montgomery parameter calculation of the arithmetic devices includes detecting a position of a most significant bit (MSB) of a modulus, calculating an initial value using position information about the detected MSB, and calculating an intermediate value and a Montgomery parameter by repeatedly performing a Montgomery addition or a Montgomery multiplication with respect to the initial value.

### CROSS-REFERENCE TO RELATED APPLICATION

This U.S. non-provisional patent application claims priority under 35 U.S.C. §119 to Korean Patent Application No. 10-2014-0099941 filed Aug. 4, 2014, the disclosure of which is hereby incorporated by reference in its entirety.

### BACKGROUND

The present inventive concepts described herein relate to arithmetic devices, a Montgomery parameter calculation method thereof, and a modular multiplication method.

An arithmetic operation based on a public key encryption algorithm which is widely used such as Rivest Shamir Adelman (RSA) and error correction code (ECC) is a modular arithmetic operation. A modular addition, a modular subtraction, and a modular multiplication are basic modular arithmetic operations. A modular exponentiation or a modular scalar multiplication which is mainly used in a real public key cipher algorithm may be obtained by performing the modular addition, the modular subtraction, and the modular multiplication operations repeatedly.

### SUMMARY

Aspects of embodiments of the present inventive concepts are directed to provide an arithmetic device which efficiently calculates a Montgomery parameter by adding a minimum resource based on existing hardware, a Montgomery parameter calculation method, and modular multiplication method thereof.

The present inventive concepts are not limited to the above disclosure, and the present inventive concepts may become apparent to those of ordinary skill in the art based on the following descriptions.

In accordance with aspects of the present inventive concepts, a method for calculating a Montgomery parameter in an arithmetic device, the Montgomery parameter calculation method may include detecting a position of a most significant bit (MSB) of a modulus, calculating an initial value using position information about the detected MSB, and calculating an intermediate value and a Montgomery parameter by repeatedly performing a Montgomery addition or a Montgomery multiplication with respect to the initial value.

In other embodiments, the Montgomery parameter calculation method may further include receiving the modulus.

In other embodiments, the Montgomery parameter calculation method may further include performing a modular subtraction with respect to the modulus before detecting the position of the most significant bit (MSB) of the modulus.

In still other embodiments, detecting the position of the MSB may include classifying the modulus in units of a word and sequentially detecting the position of the MSB with respect to the classified words.

In yet other embodiments, detecting the position of the MSB may include scanning the MSB which is non-zero.

In yet other embodiments, detecting the position of the MSB may include counting the number of zeros until the MSB which is non-zero is detected.

In yet other embodiments, the intermediate value may be calculated by performing the Montgomery addition from the position of the MSB.

In yet other embodiments, the intermediate value may be calculated by performing the Montgomery addition from a position of a next bit of the MSB.

In yet other embodiments, the intermediate value may be 2^{(word}^{_{—}}^{sz+word}^{_{—}}^{sz/div)*word}^{_{—}}^{num} mod M, where word_sz is a size of a word, div is a hardware constant, word_num is the number of a word and M is the modulus.

In yet other embodiments, the Montgomery parameter may be 2^{word}^{_{—}}^{sz*word}^{_{—}}^{num*2} mod M.

In yet other embodiments, the Montgomery parameter may be calculated by repeatedly performing the Montgomery multiplication as many times as the number of a corresponding count within a range where word_sz/div becomes an integer.

In yet other embodiments, the Montgomery parameter calculation method may further include storing the Montgomery parameter in a storage device.

In accordance with other aspects of the present inventive concepts, arithmetic devices may include a Montgomery arithmetic unit configured to perform a Montgomery arithmetic operation, and a Montgomery arithmetic unit controller configured to control the Montgomery arithmetic unit, to detect an MSB of a modulus, to calculate an initial value corresponding to a position of the detected MSB, and to calculate an intermediate value and a Montgomery parameter while the Montgomery arithmetic unit repeatedly performs a Montgomery addition or a Montgomery multiplication with respect to the initial value.

In some embodiments, the Montgomery arithmetic unit controller may include a modular checker for detecting the MSB of the modulus.

In other embodiments, the modular checker may detect a non-zero bit in units of words.

In yet other embodiments, the Montgomery arithmetic unit controller may include a sequence controller configured to control the Montgomery arithmetic unit so that the Montgomery arithmetic unit can repeatedly perform the Montgomery addition or the Montgomery multiplication. The sequence controller is configured to calculate the Montgomery parameter from the initial value.

In yet other embodiments, the arithmetic device may further include a storage device configured to store the initial value, a result value of the Montgomery addition, or a result value of the Montgomery multiplication.

In yet other embodiments, the initial value may be calculated by performing the Montgomery addition from a position corresponding to the MSB.

In accordance with still other aspects of the present inventive concepts, a method or performing a Montgomery multiplication in an arithmetic device may include calculating a Montgomery parameter from position information with respect to a most significant bit (MSB) of a modulus, transforming operands into a Montgomery domain using the Montgomery parameter, performing a Montgomery multiplication with respect to the transformed operands, and transforming a result value of the Montgomery multiplication into an integer domain through an inverse arithmetic operation using the Montgomery parameter.

Arithmetic devices and a method of operating thereof according to embodiments of the present inventive concepts may efficiently calculate a Montgomery parameter by adding minimum hardware using a Montgomery modular arithmetic unit.

Arithmetic devices and a method of operating thereof according to embodiments of the present inventive concepts may reduce a gate count of total hardware and power consumption by using a size of an operating register in units of words in order to minimize a size of hardware.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram briefly illustrating a modular multiplication method according to embodiments of the present inventive concepts:

FIG. 2 is a block diagram exemplarily illustrating arithmetic devices 10 according to embodiments of the present inventive concepts;

FIG. 3 is a flow chart illustrating a method of calculating a Montgomery parameter R² mod M of arithmetic devices according to embodiments of the present inventive concepts;

FIG. 4 is a diagram exemplarily illustrating a method of searching an MSB position of a modulus M shown in FIG. 2;

FIG. 5 is a diagram illustrating embodiments with respect to a process to calculate an intermediate value R₀ mod M from a modulus M;

FIG. 6 is a diagram illustrating embodiments with respect to a process to calculate an intermediate value R₀ mod M from another modulus M;

FIG. 7 is a diagram illustrating other embodiments with respect to a process to calculate an intermediate value R₀ mod M from a modulus M;

FIG. 8 is a flow chart illustrating a process for calculating a Montgomery modular multiplication based on a hardware constant div according to embodiments of the present inventive concepts;

FIG. 9 is a block diagram illustrating arithmetic devices 20 according to other embodiments of the present inventive concepts; and

FIG. 10 is a block diagram illustrating security systems 1000 having cipher processors according to embodiments of the present inventive concepts;

### DETAILED DESCRIPTION

Advantages and features of the present inventive concepts and methods of accomplishing the same may be understood more readily by reference to the following detailed description of exemplary embodiments and the accompanying drawings. The present inventive concepts may, however, be embodied in many different forms and should not be construed as being limited to the embodiments set forth herein. Rather, these embodiments are provided so that this disclosure will be thorough and complete and will fully convey the present inventive concepts to those skilled in the art, and the present inventive concepts will only be defined by the appended claims. In the drawings, the thickness of layers and regions are exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

The use of the terms “a” and “an” and “the” and similar referents in the context of describing the embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present inventive concepts.

Unless defined otherwise, all technical and scientific terms used herein have the same meaning as commonly understood by one of ordinary skill in the art to which the present inventive concepts belong. It is noted that the use of any and all examples, or exemplary terms provided herein is intended merely to better illuminate the present inventive concepts and is not a limitation on the scope of the present inventive concepts unless otherwise specified. Further, unless defined otherwise, all terms defined in generally used dictionaries may not be overly interpreted.

Embodiments will be described in detail with reference to the accompanying drawings. Generally, Montgomery arithmetic may efficiently perform modular arithmetic when a modulus is large. Among a modular addition, a modular subtraction and a modular multiplication, the modular multiplication may be most expensive. Since a cost of a reduced production with respect to a general modular multiplication is great, modular multiplication may be embodied in Montgomery multiplication. Here, the Montgomery multiplication is a method for transforming an integer domain into a Montgomery domain, and the Montgomery multiplication may operate a Montgomery parameter.

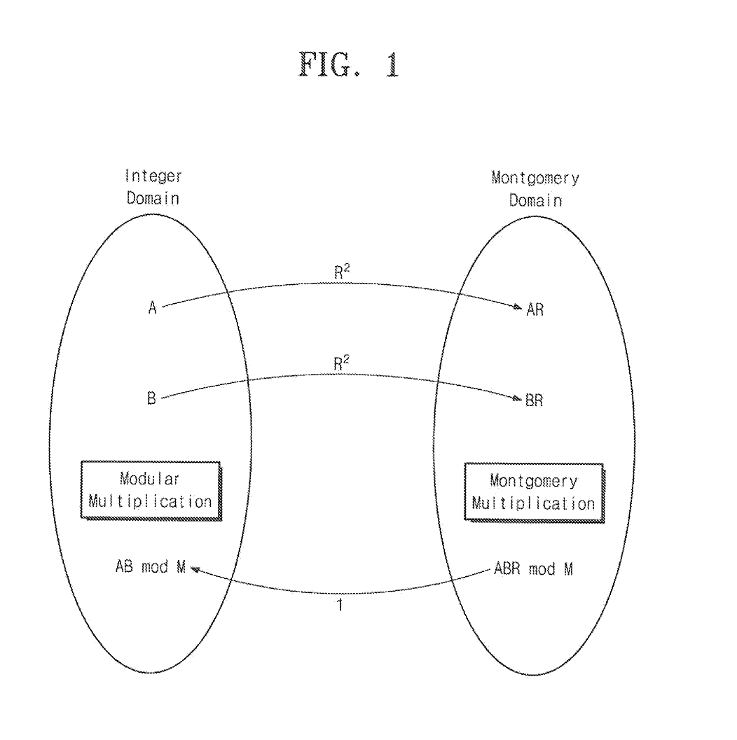

FIG. 1 is a diagram briefly illustrating a modular multiplication method according to embodiments of the present inventive concepts. Referring to FIG. 1, a modular multiplication AB mod M of operands A and B in an integer domain may be transformed into a Montgomery multiplication ABR mod M of operands AR and BR transformed in the Montgomery domain. For a Montgomery domain transformation, a Montgomery domain parameter R or R2 may be needed. Here, M is a value of a modulus.

Generally, when a minimum resource is added to hardware where modular addition, subtraction, and multiplication are implemented, a Montgomery domain parameter R, which is a value needed to calculate a modular exponentiation through domain conversion, can be calculated. A definition of the Montgomery domain parameter according to embodiments of the present inventive concepts is as follows.

When M<R, gcd(R, M)=1, M<R, and |M| is an operand size of M, the Montgomery domain parameter R is 2^{x} (x≧|M|).

The result value ABR mod M performed in the Montgomery domain may be transformed into the modular multiplication AB mod M in an integer domain through an inverse arithmetic operation using a Montgomery parameter.

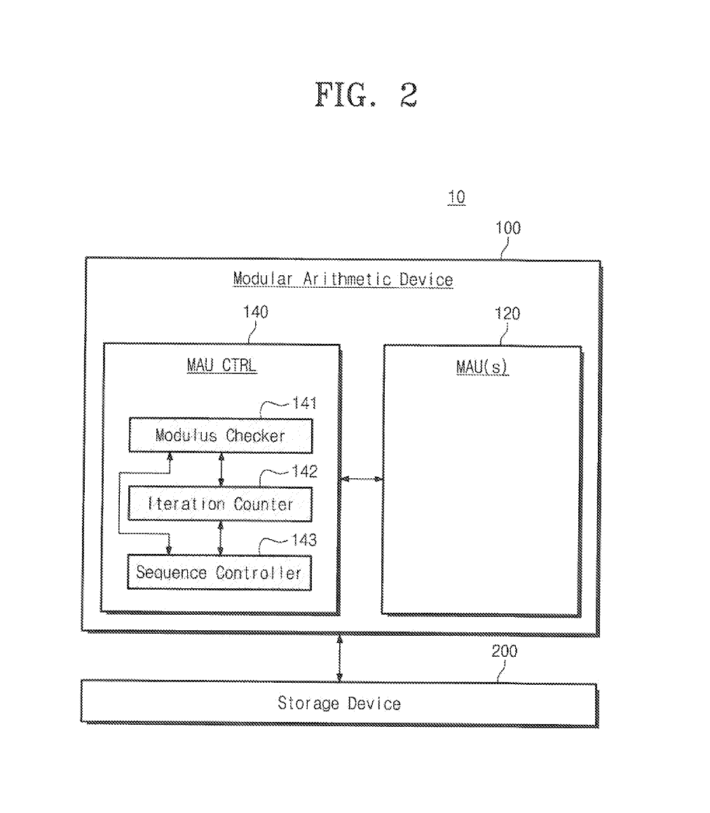

FIG. 2 is a block diagram exemplarily illustrating arithmetic devices 10 according to embodiments of the present inventive concepts. Referring to FIG. 2, arithmetic devices 10 may include a modular arithmetic device 100 and a storage device 200 which stores at least one input value to be needed during an arithmetic operation thereof, a least one medium value generated during the arithmetic operation, and a least one result value generated during the arithmetic operation.

As shown in FIG. 2, the modular arithmetic device 100 may include at least one Montgomery arithmetic unit MAU 120 and a Montgomery arithmetic unit controller MAU CTRL 140 for controlling the Montgomery arithmetic unit MAU 120.

The Montgomery arithmetic unit MAU 120 may receive operands in a Montgomery domain to perform Montgomery arithmetic operations. In some embodiments, the Montgomery arithmetic operations may be a modular addition, a modular subtraction, or a modular multiplication.

The Montgomery arithmetic unit controller MAU CTRL 140 may control the Montgomery arithmetic unit MAU 120. The Montgomery arithmetic unit controller MAU CTRL 140 may include a modulus checker 141, an iteration counter 142, and a sequence controller 143.

As shown in FIG. 1, the modulus checker 141 may detect a position of a most significant bit (MSB) of a modulus M in order to calculate an initial value IV that is used for calculating a Montgomery parameter R² mod M.

The iteration counter 142 may perform an arithmetic counting of a modular addition according to an MSB of an operand size and a position of a modulus M.

The sequence controller 143 may control a modular arithmetic sequence for performing the Montgomery parameter R² mod M calculation.

The storage device 200 may store an input and output value for a Montgomery arithmetic operation and a middle arithmetic result value. In some embodiments, as shown in FIG. 2, the storage device 200 may be implemented outside the modular arithmetic device 100. For example, the storage device 200 may be embodied in a volatile memory device such as a static random access memory (SRAM) or a dynamic random access memory (DRAM), or in a nonvolatile memory device such as a phase-change random access memory (PRAM) or a magnetic random access memory (MRAM). In other embodiments, the storage device 200 may be implemented with a type of a register which is composed in the modular arithmetic device 100.

The arithmetic devices 10 according to embodiments of the present inventive concepts may be applied to all arithmetic operators for performing the modular addition, the modular subtraction and the modular multiplication, and may calculate the Montgomery parameter R² mod M with adding a minimum hardware resource compared with the related art.

Further, even though implemented with a minimum hardware size, the arithmetic devices 10 according to embodiments of the present inventive concepts may not generate unneeded cycle overhead for a large operand size. Accordingly, arithmetic devices 10 and a modular arithmetic method thereof according to embodiments of the present inventive concepts may reduce operating time of the Rivest Shamir Adelman (RSA) and elliptic curve cryptosystems (ECC) arithmetic operation time when implemented with hardware.

The arithmetic devices 10 and a modular arithmetic method thereof according to embodiments of the present inventive concepts may utilize a size of an inside operating register in units of words in order to minimize a size of hardware. Therefore, a gate count of the whole hardware, and power consumption, may be reduced.

Moreover, the arithmetic devices 10 and a modular arithmetic method thereof according to embodiments of the present inventive concepts may calculate the Montgomery parameter R² mod M by repeatedly performing modular addition and modular multiplication in units of words. A memory approach may occur during a modular operation in parallel. Accordingly, the arithmetic devices 10 and a modular arithmetic method thereof according to embodiments of the present inventive concepts may improve operating speed by maximally reducing a number of counts of the whole memory approach.

Further, the arithmetic devices 10 and a modular arithmetic method thereof according to embodiments of the present inventive concepts may be implemented based on the modular arithmetic unit 120. The arithmetic devices 10 and a modular arithmetic method may check an MSB in a modulus M in order to calculate an initial value IV for computing the Montgomery parameter R² mod M, and may calculate an intermediate value by repeatedly performing the modular addition in the initial value IV. A result value of this modular addition may be efficiently corrected according to a sign of an input value. Therefore, modular subtraction arithmetic for comparing a size may not be needed in modular addition arithmetic for calculating the intermediate value. As a result, the total count of the modular addition operations may be reduced. The operating speed may be improved by the reduced number of operations.

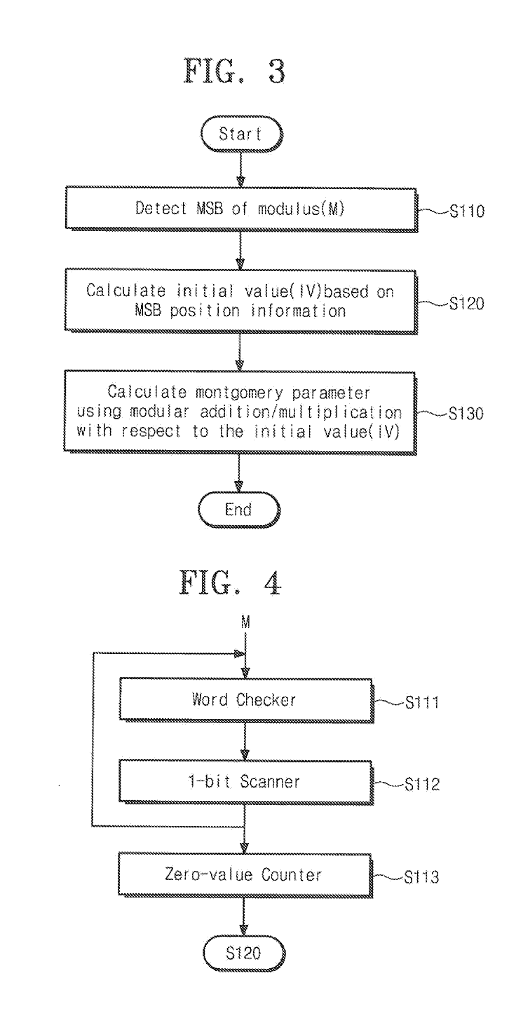

FIG. 3 is a flow chart illustrating a method of calculating a Montgomery parameter R² mod M of arithmetic devices according to embodiments of the present inventive concepts. Referring to FIGS. 1 to 3, a method of calculating the Montgomery parameter R² mod M is as follows.

A modulus M may be input. A position of an MSB of the input modulus M may be searched (S110). For example, an MSB position search operation may be performed by counting the number of zero values located in front of the MSB. Because hardware according to embodiments of the present inventive concepts is implemented with a bandwidth in units of words, arithmetic devices 10 may sequentially read the modulus M from a most significant word in units of words, and may determine whether a value of the modulus M is “0”. If a corresponding word has a value of “0”, the arithmetic devices 10 may sequentially read the next word. If not, the position of the MSB which is non-zero in the corresponding word may be searched. Therefore, the number of a value of “zero” which is located in front of the MSB may be calculated. In one embodiment, the arithmetic devices may perform a modular subtraction M−M mod M with respect to the modulus M before searching the position of the MSB.

When the position of the MSB which is non-zero is searched through an MSB detection operation, an initial value IV may be calculated.

The initial value IV may be satisfied with Equation below.

IV=2^{word}^{_{—}}^{sz*word}^{_{—}}^{num-zero}^{_{—}}^{num} [Equation1]

Here, word_sz is a size of a word. Word_num is the number of a word. Zero_num is the number of “zero” which is located in front of an MSB. Meanwhile, power, which is an index of an intermediate value, is defined as follows:

power=(word_{—}sz+(word_{—}sz/div))*word_{—}num [Equation 2]

Here, div is a constant with respect to hardware and word_sz/div is an integer. The intermediate value R₀ mod M may be calculated using the initial value IV and the number of “zero” (S120). The intermediate value R₀ mod M may be calculated with Equation below.

R₀ mod M=2^{(word}^{_{—}}^{sz+(word}^{_{—}}^{sz/div))*word}^{_{—}}^{num} mod M [Equation 3]

The Montgomery parameter R² mod M may be calculated by repeatedly performing a modular addition or a modular multiplication with respect to the intermediate value R₀ mod M (5130).

FIG. 4 is a diagram exemplarily illustrating a method of searching an MSB position of a modulus M shown in FIG. 2. Referring to FIGS. 1 to 4, a method of searching the position of an MSB of the modulus M is as follows. The modulus M may be searched in units of words in order to calculate the position of the MSB of the modulus M in a word check or a modulus check 141 (S111). Arithmetic devices 10 may identify that the MSB is located in a value of a word corresponding to the modulus M. That is, the arithmetic devices 10 may determine whether the MSB has zero value. When the MSB is located in the corresponding word, a scanning operation for searching the position of the MSB in a 1-bit scanner may be performed (S112). A zero value counter may calculate and output the number of zero values located in front of the MSB for calculating the number of an operation of a modular addition (S113).

Through the described MSB detection process, when the arithmetic device 10 searches the position of the MSB which is non-zero, the initial value IV for calculating an intermediate value R₀ mod M may be calculated. A method of calculating the initial value IV and the number of arithmetic count of a modular addition is described below.

In a process for detecting a non-zero MSB of the modulus M, a maximum arithmetic cycle may be changed depending on an operand size of the modulus M and on whether the MSB is located in an nth word. However, the modulus M corresponding to a maximum consumption cycle may not be used as an input. Although the process for detecting the non-zero MSB of the modulus M accounts for a small part in the whole arithmetic cycle for calculating the Montgomery parameter R² mod M, a value calculated through this process may be calculated through the number a modular addition arithmetic for calculating the intermediate value R₀ mod M.

As described, when the arithmetic device 10 detects the position of the MSB of the modulus M, a variable having a value of “1” may be stored at the corresponding position. The variable may be the initial value IV for calculating the intermediate value R₀ mod M. The intermediate value R₀ mod M may be calculated by repeatedly performing modular addition arithmetic using the number of “0” located in front of the MSB of the modulus M and the initial value IV.

Meanwhile, the number of modular addition operations to be performed according to the operand size of the modulus M and the number of “0” located in front of the MSB may be changed.

A method of calculating the initial value IV for calculating the intermediate value R₀ mod M in the modulus M and a method of calculating the number of modular additions may be described as below. For convenience of a description, it is assumed that the operand-size of the modulus M is 128 bits, word_sz is 32, word_num is 4, div is 16, and R₀ mod M is 2¹³⁶.

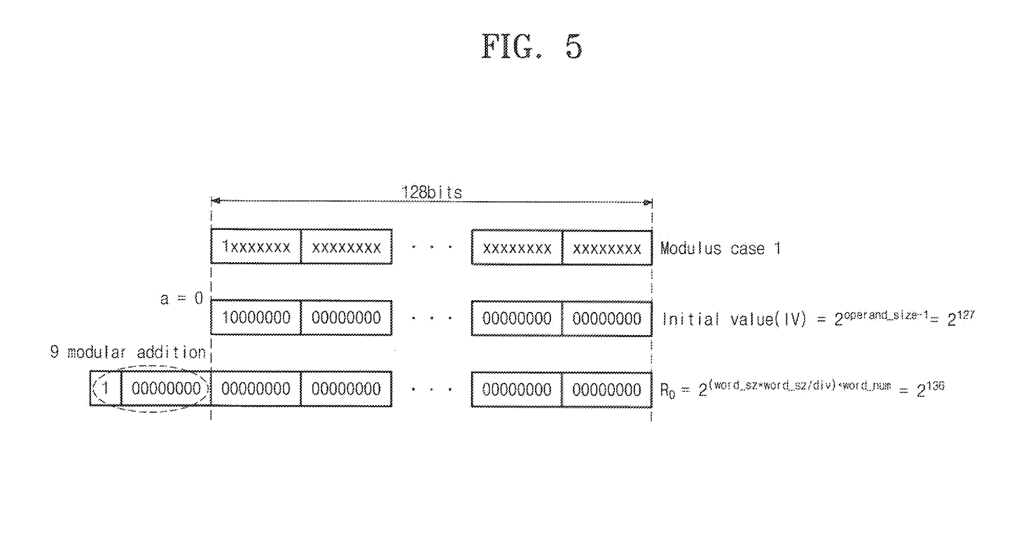

FIG. 5 is a diagram illustrating embodiments with respect to a process for calculating an intermediate value R₀ mod M from a modulus M. Referring to FIG. 5, a value having a value of “1” at a position of an MSB of the modulus M may be used as an initial value IV. The intermediate value R₀ mod M may be calculated by starting from the initial value IV and performing a modular addition nine times.

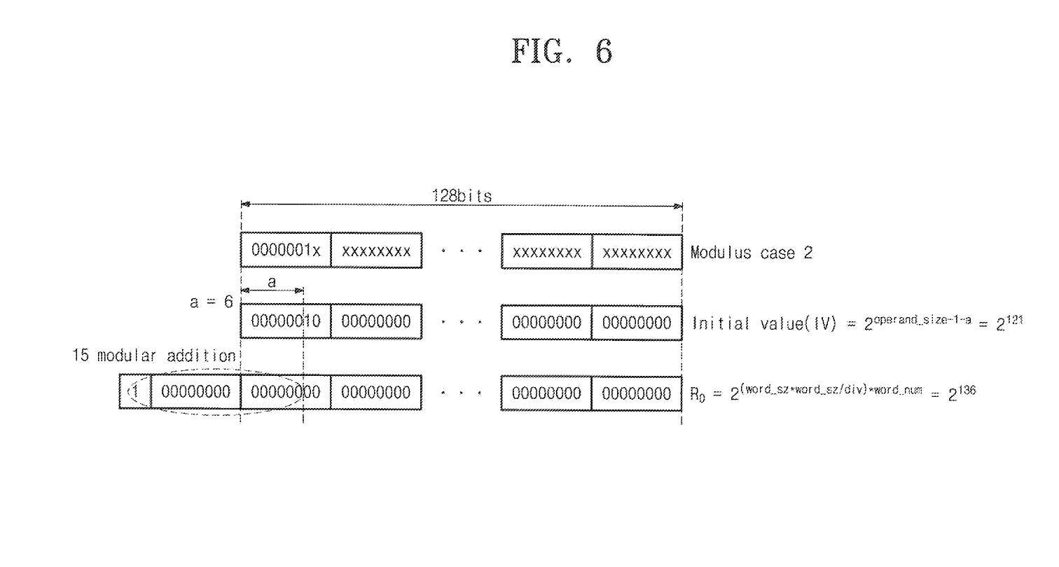

FIG. 6 is a diagram illustrating an embodiment with respect to a process for calculating an intermediate value R₀ mod M from another modulus M. Referring to FIG. 6, a value having a value of “1” at a position of an MSB of a modulus M may be used as an initial value IV. The intermediate value R₀ mod M may be calculated by starting from the initial value IV and performing a modular addition fifteen times. Here, “a” is the number of a zero head of the MSB in the modulus M.

Meanwhile, as shown in FIGS. 5 and 6, the initial value IV may not be needed with the value of “1” at the position of the MSB of the modulus M. Further, the initial value IV having the value of “1” in front of the position of the MSB of the modulus M may be set.

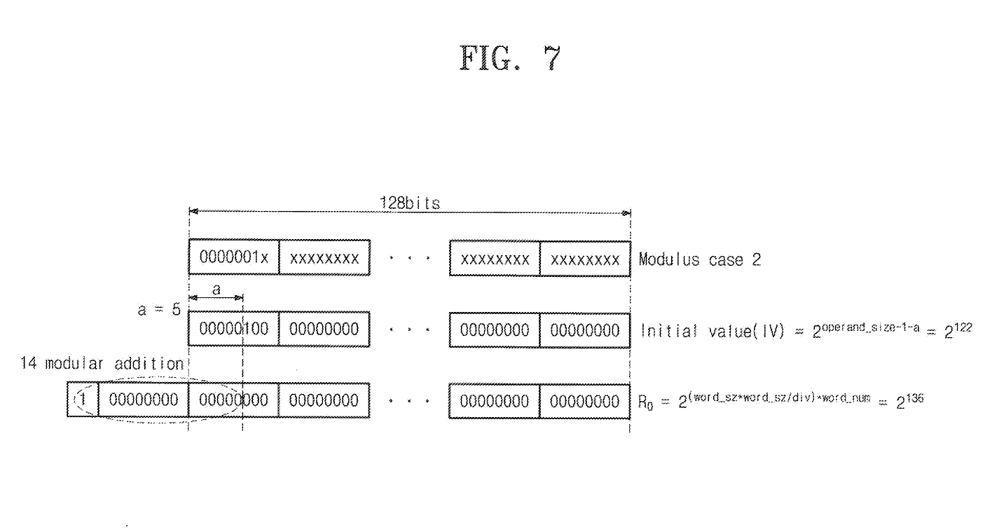

FIG. 7 is a diagram illustrating other embodiments with respect to a process for calculating an intermediate value R₀ mod M from a modulus M. Referring to FIG. 7, the number of modular addition arithmetic operations for calculating an intermediate value R₀ mod M may be reduced to a reduced count by setting an initial value IV having a value of “1” prior to a position of an MSB of the modulus M.

The number of modular addition arithmetic operations for calculating the intermediate value of R₀ mod M may be defined according to the number of a word word_num and the number of zeroes located in front of the MSB of the modulus M as follows.

[Equation 4]

2*word_{—}num+a+1 [Equation 4]

Here, “a” is the number of “0” which is successive until “1” comes up in the MSB of the modulus M. A modular addition may be repeatedly performed as many times as the number corresponding to Equation 4 for calculating R₀ mod M.

A modular addition scheme according to embodiments of the present inventive concepts may have a result value corresponding to −M<result <M. Accordingly, a modular addition arithmetic operation may be performed as many times as the corresponding repeated count without an additional arithmetic operation for correcting a result value. Further, the initial value IV for calculating R₀ mod M may be calculated by getting a value of “1” from the position of the MSB of the modulus M to a position in front of a few bits. Therefore, an operating speed may be improved by reducing the number of repeated modular addition operations.

The next is a table for comparing the number of modular arithmetic operations for calculating the intermediate value R₀ mod M with that of the related art.

TABLE 1

| | |
|---|---|
| The related | The present inventive |
| art | concepts |

| | ADD | SUB | ADD |
|---|---|---|---|
| 256 bits | 17 | 6 | 17 |
| 1024 bits | 65 | 22 | 65 |
| 2049 bits | 129 | 44 | 129 |

However, the number of modular arithmetic operations may be calculated under at least two conditions. Firstly, it is assumed that a zero value is not in front of the MSB of the modulus M. Accordingly, the modular arithmetic operations may increase as many as the number of zero values. Secondly, a value of a hardware constant may be fixed, for example, as 16 such that the number of Montgomery multiplications with respect to the intermediate value R₀ mod M for calculating a Montgomery parameter R² mod M may be, for example, 4. The hardware constant div may be selected according to hardware implementation in a range where word_sz/div becomes an integer.

Referring to Table 1, when the intermediate value R₀ mod M according to embodiments of the present inventive concepts is calculated, an operating cycle may be reduced because an arithmetic operations corresponding to a subtraction of the related art is eliminated.

Finally, a value of the Montgomery parameter R² mod M may be calculated by repeatedly performing a Montgomery modular multiplication using the intermediate value R₀ mod M. As mentioned earlier, the number of a modular multiplication may be changed depending on how the hardware constant div is defined in the intermediate value R₀ mod M which is represented as 2^{(word}^{_{—}}^{sz+(word}^{_{—}}^{sz/div))*word}^{_{—}}^{num} mod M.

Because arithmetic operating time of the Montgomery multiplication is much longer than a modular addition, when the number of an operating count of the Montgomery multiplication increases as an operand size increases, operating speed may be slow. Accordingly, Montgomery arithmetic according to embodiments of the present inventive concepts may regulate the number of the repeated count of the Montgomery multiplication operations. Therefore, the operating speed may improve by determining the efficient operating count for various operand sizes.

A method of the Montgomery arithmetic according to embodiments of the present inventive concepts may calculate a Montgomery domain parameter through adding a hardware resource. The method of the Montgomery arithmetic according to embodiments of the present inventive concepts may reduce the number of modular addition and modular subtraction operations in the whole operating process by detecting the MSB of the modulus M and by calculating the initial value IV and the number of modular addition operations. As a result, operating time may be reduced.

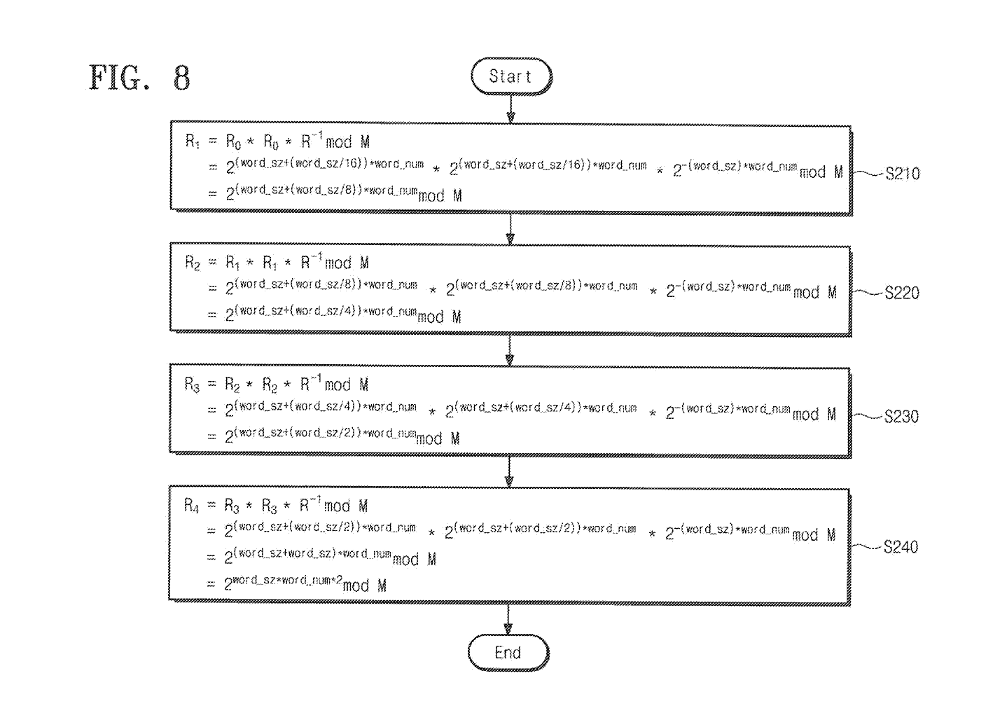

FIG. 8 is a flow chart illustrating a process for calculating a Montgomery modular multiplication based on a hardware constant div according to embodiments of the present inventive concepts. Referring to FIGS. 1 to 8, a process for calculating a Montgomery parameter R² mod M is as follows. For convenience of a description, it is assumed that the hardware constant div is 16.

A first Montgomery multiplication may be performed with respect to an intermediate value R₀ mod M. As a result of the first Montgomery multiplication, a first arithmetic value R₁ may be calculated (S210). Here, the first arithmetic value R₁ may be satisfied with Equation 5.

R₁=2^{(word}^{_{—}}^{sz+(word}^{_{—}}^{sz/8))*word}^{_{—}}^{num} mod M [Equation 5]

A second Montgomery multiplication may be performed with respect to the first arithmetic value R₁. As a result of the second Montgomery multiplication, a second arithmetic value R₂ may be calculated (S220). Here, the second arithmetic value R₂ may be satisfied with Equation 6.

R₂=2^{(word}^{_{—}}^{sz+(word}^{_{—}}^{sz/4))*word}^{_{—}}^{num} mod M [Equation 6]

A third Montgomery multiplication may be performed with respect to the second arithmetic value R₂. As a result of the third Montgomery multiplication, a third arithmetic value R₃ may be calculated (S230). Here, the third arithmetic value R₃ may be satisfied with Equation 7.

R₃=2^{(word}^{_{—}}^{sz+(word}^{_{—}}^{sz/2))*word}^{_{—}}^{num} mod M [Equation 7]

A fourth Montgomery multiplication may be performed with respect to the third arithmetic value R₃. As a result of the fourth Montgomery multiplication, a fourth arithmetic value R₄ may be calculated (S240). Here, the fourth arithmetic value R₄ may be satisfied with Equation 8.

R₄=2^{word}^{_{—}}^{sz*word}^{_{—}}^{num*2} mod M [Equation 8]

Consequently, the fourth arithmetic value R₄ may become a Montgomery parameter R² mod M.

Meanwhile, arithmetic devices 10 shown in FIG. 2 may exist outside a modular arithmetic device 100. The present inventive concepts are not necessarily limited hereto. A memory device may be implemented in a modular arithmetic device.

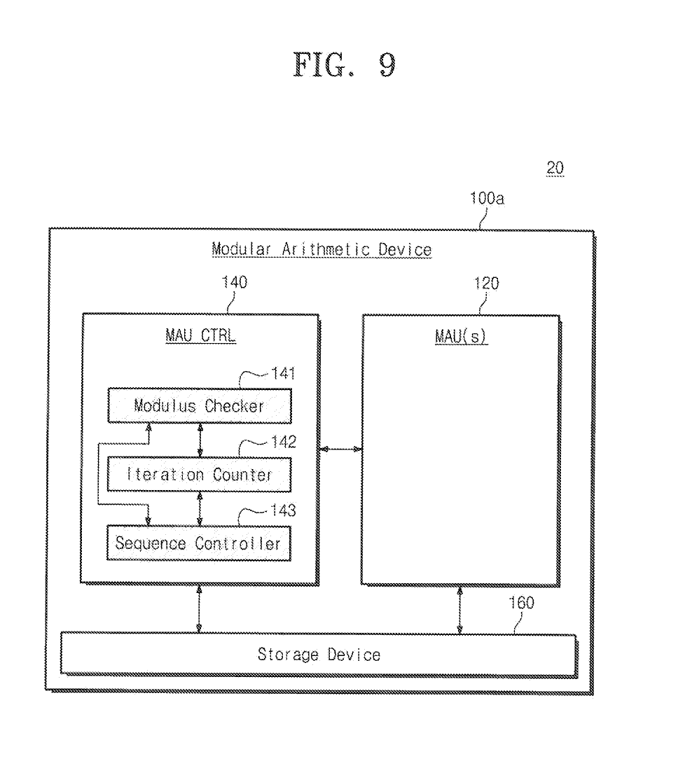

FIG. 9 is a block diagram illustrating arithmetic devices 20 according to other embodiments of the present inventive concepts. Referring to FIG. 9, modular arithmetic devices 100a for composing an arithmetic device 20 may include a modular arithmetic unit 120, a modular arithmetic unit controller 140 and a storage device 160. Compared with that shown in FIG. 2, the modular arithmetic device 100a may include the storage device 160 inside the modular arithmetic device 100a.

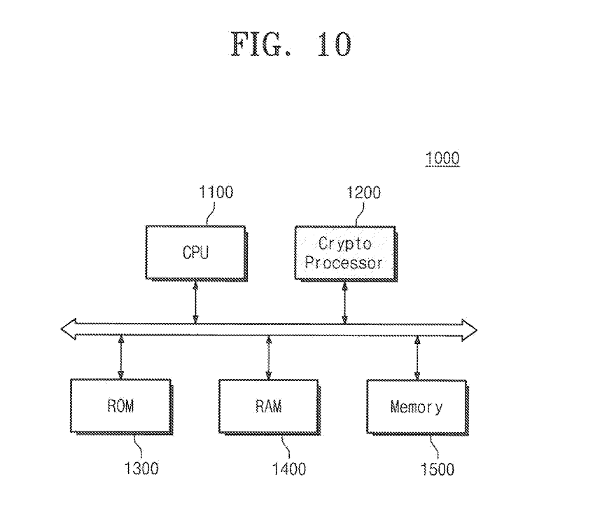

FIG. 10 is a block diagram illustrating security systems 1000 having a crypto processor according to embodiments of the present inventive concepts. Referring to FIG. 10, the security system 1000 may include a central processing unit (CPU) 1100, a crypto processor 1200, a read only memory (ROM) 1300, a random access memory (RAM) 1400, and a memory 1500. In an embodiment, the security system 1000 may be a smart card.

The CPU 1100 may control an overall operation of the security system 1000. The crypto processor 1200 may decode a command which is able to do a cipher, an authority, and an electric signature and processes data.

The crypto processor 1200 may be implemented to perform an encryption operation and a decryption operation using a Montgomery arithmetic method described in FIGS. 1 to 8. The ROM 1300 and the RAM 1400 may store data for operating the security system 1000. The memory 1500 may store data for operating the crypto processor 1200.

Compared with the related art, security systems 1000 according to embodiments of the present inventive concepts may reduce hardware resources and may also reduce operating time.

While the present inventive concepts have been described with reference to exemplary embodiments, it will be apparent to those skilled in the art that various changes and modifications may be made without departing from the spirit and scope of the present inventive concepts. Therefore, it should be understood that the above embodiments are not limiting, but illustrative.

What is claimed is:

1. A method for calculating a Montgomery parameter in an arithmetic device, the method comprising:
detecting a position of a most significant bit (MSB) of a modulus;
calculating an initial value using position information about the detected MSB; and
calculating an intermediate value and a Montgomery parameter by repeatedly performing a Montgomery addition and/or a Montgomery multiplication with respect to the initial value.

2. The method of claim 1, further comprising receiving the modulus.

3. The method of claim 1, further comprising performing a modular subtraction with respect to the modulus before detecting the position of the MSB of the modulus.

4. The method of claim 1, wherein detecting the position of the MSB of the modulus includes classifying the modulus in units of a word and sequentially detecting the position of the MSB of the modulus with respect to the classified words.

5. The method of claim 4, wherein detecting the position of the MSB of the modulus includes scanning the MSB which is non-zero.

6. The method of claim 5, wherein detecting the position of the MSB of the modulus includes counting the number of zero until the MSB which is non-zero is detected.

7. The method of claim 1, wherein the intermediate value is calculated by performing the Montgomery addition from the position of the MSB.

8. The method of claim 1, wherein the intermediate value is calculated by performing the Montgomery addition from a position of a next bit of the MSB.

9. The method of claim 1, wherein the intermediate value is 2^{(word}^{_{—}}^{sz+word}^{_{—}}^{sz/div)*word}^{_{—}}^{num} mod M, where word_sz is a size of a word, div is a hardware constant, word_num is the number of a word and M is the modulus.

10. The method of claim 9, wherein the Montgomery parameter is 2^{word}^{_{—}}^{sz*word}^{_{—}}^{num*2} mod M.

11. The method of claim 9, wherein the Montgomery parameter is calculated by repeatedly performing the Montgomery multiplication as many times as the number of a corresponding count within a range where word_sz/div becomes an integer.

12. The method of claim 1, further comprising storing the Montgomery parameter in a storage device.

13. An arithmetic device comprising:
a Montgomery arithmetic unit configured to perform a Montgomery arithmetic operation;
a Montgomery arithmetic unit controller configured to control the Montgomery arithmetic unit, to detect an MSB of a modulus, to calculate an initial value corresponding to a position of the detected MSB, and to calculate an intermediate value and a Montgomery parameter,
wherein the Montgomery arithmetic unit is configured to repeatedly perform a Montgomery addition and/or a Montgomery multiplication with respect to the initial value.

14. The arithmetic device of claim 13, wherein the Montgomery arithmetic unit controller includes a modular checker configured to detect the MSB of the modulus.

15. The arithmetic device of claim 14, wherein the modular checker is configured to detect a non-zero bit in units of words.

16. The arithmetic device of claim 13, wherein the Montgomery arithmetic unit controller includes a sequence controller configured to control the Montgomery arithmetic unit so that the Montgomery arithmetic unit is configured to repeatedly perform the Montgomery addition and/or the Montgomery multiplication, and
the sequence controller is configured to calculate the Montgomery parameter based on the initial value.

17. The arithmetic device of claim 13, further comprising a storage device configured to store the initial value, a result value of the Montgomery addition and/or a result value of the Montgomery multiplication.

18. The arithmetic device of claim 13, wherein the initial value is calculated by performing the Montgomery addition from the position corresponding to the MSB.

19. The arithmetic device of claim 13, wherein the Montgomery arithmetic unit is configured to receive operands in a Montgomery domain.

20. A method for performing a Montgomery multiplication in an arithmetic device, the method comprising:
calculating a Montgomery parameter from position information with respect to a most significant bit (MSB) of a modulus;
transforming operands into a Montgomery domain using the Montgomery parameter;
performing the Montgomery multiplication with respect to the transformed operands; and
transforming a result value of the Montgomery multiplication into an integer domain through an inverse arithmetic operation using the Montgomery parameter.
